(19) United States
(12) Patent Application Publication
(10) Pub. No.: US 2003/0218632 A1
(43) Pub. Date: Nov. 27, 2003

(54) Method and architecture of an event transform oriented operating environment for a personal mobile display system

(76) Inventors: Tony Altwies, San Jose, CA (US); Migdat Hodzic, Cupertino, CA (US); Tom Rioux, Morgan Hill, CA (US); Jiangmin Wu, Daly City, CA (US)

Correspondence Address: DOUGLAS A. CHAIKIN, PENINSULA IP GROUP, Suite 101, 2290 North First Street, San Jose, CA, 95131, US

(21) Appl. No.: 10/155,601

(22) Filed: May 23, 2002

(51) Int. Cl. G09G 5/00

(52) U.S. Cl. 345/740; 345/755

(57) ABSTRACT

Disclosed herein is a personal mobile display system that operate in cooperation with a remote system that include a processor for executing PC compatible application programs capable of generating and displaying a plurality of operational functions and data in response to user specified input. In addition, the present invention is directed to a method of providing event driven functionality that allows a personal mobile display system to system to cooperatively execute application programs in conjunction with a remote computer system by detecting that a change to the functionality, appearance and logical position of an application-oriented functional element and categorizing type of event. Once categorized the present invention encapsulates one or more events as an event transform to be transmitted to a corresponding remote computer system. Here the event transform is an encapsulation of a source event, method and or actions that may be moved in space and or instance in time that is transmitted from the personal mobile display system to the remote computer system. Once the corresponding system processes the event transform and transmits it back to the personal mobile display system to reconstruct and display the changes in the form of one or more rectangular display segments that were encapsulated in the received event transforms in accordance with the application program from the remote computer system.

### BACKGROUND OF THE INVENTION

1. Field of the Invention

The present invention is generally related to mobile, interactive communications systems. More particularly, this invention relates to a personal computer access and communications system that permits immediate interactive access to and the use of an array of user-specified application programs on a corresponding host computer system through a wireless network.

2. Description of the Related Art

Computers are becoming increasingly powerful, lightweight, and portable. The computing power of computers that once filled entire rooms is now residing on a desktop. Laptop, notebook, and sub-notebook computers are virtually as powerful as their desktop counterparts. Even smaller hand-held systems are capable of performing tasks that required a much larger system a few short years ago.

As a part of this trend, personal organizers or personal digital assistants (PDA) are becoming increasingly popular with a large segment of the population. Personal digital assistants tend to be small, lightweight, relatively inexpensive, and can perform such functions as keeping a calendar, an address book, a to-do list, etc. While many of these functions can also be provided in conventional computer systems, personal organizers are very well suited to the personal organization task due to their small size and portability.

As the demand for user-specified functionality via a wireless has increased substantially, a new class of systems has evolved to meet this demand. Often referred to as a thin client/server-networking environment, it has been driven by a substantial growth of wireless accessible resources including the Internet. This new form of portable computing device is often called a pen-based computer system. Initially, these systems only implemented a minimum of functions including a thin network protocol, a network interface, a video display interface, some sort of input mechanism and just enough computational and memory resources to minimally support operation of a dedicated Web browser application.

More recently, pen-based display tablet systems have married the power of a general-purpose desktop computer with the functionality and reduced size of a personal digital assistant. The new form of pen-based display tablet system is slightly larger than a hand-held device, rectangular in shape, about the size of an eight and half by eleven-inch piece of paper and employs a “pen” or stylus as the primary input device. Typically, these systems include a flat panel touch display screen that functions as both an input and output device, a relatively high performance micro-controller or processor and sufficiently memory space to support both an embedded operating system as well as a set of pre-installed applications.

The touch screen display of the pen-based display tablet system permits users to operate the system as a computerized notepad, for example. Graphic images are input to the pen-based display tablet system by merely moving the stylus across the surface of the screen. As the pen-based display tablet system's micro-controller or processor senses the position and movement of the stylus, it generates a corresponding image on the screen, thus, creating the illusion that the stylus is drawing the image directly upon the screen. When the stylus crosses the surface of the screen a plurality of pixels are electronically excited in such a manner that it appears that the stylus is leaving a trail of “ink” on the display. With the appropriate application software, the movement of the stylus over the surface of the display is recognized as either text, numeric, or graphics input to the pen-based display tablet system.

In addition, with the recent expansion of the distribution of information via internet-worked or inter-networked based systems, a need has arisen to coordinate the exchange and development of data and application content among users that are typically separated from their computers systems. In many cases, the information that needs to be shared or created requires a collaborative or simultaneous use of a particular application. Here, applications are created and implemented by utilizing a form of virtual windows display that is managed by a graphical user interface (GUI) based operating system such as X-Windows systems used with many Unix-based operating systems, MicroSoft's MS-Windows 98, Windows 2000 as well as an future MS-Windows based operating environment.

With this approach a small applications window or display permits a limited degree of flexibility in controlling such thing as where data and application content is stored, whether an application is locally or remotely executed and displayed. Although this kind of capability is currently available, use of an application program to interactively or simultaneously exchange and create information is not readily available. The application programs that support any kind of remote collaborative interactivity are highly proprietary, in that, the manner and nature of collaboration is strictly controlled by the application and, as such, is confined to the functions of that application.

Proprietary collaborative applications such as these are of limited value because the functions supported by the application are specifically suited and limited to that particular application. Often, the particular functions required by the collaborative application program to function as intended bar other applications from functioning at the same time or in the same manner on a participating systems. In addition, a high degree of additional system and processing resources are required to support such applications. Furthermore, the cost of supporting such collaborative application systems are incrementally more expensive than the systems and networks that support a typical array of conventional networked application. Thus, these application systems are only effective in situations where that particular functionality is a requirement.

An alternative to a proprietary collaborative application system is a technology known as window sharing. In a typical window-sharing environment, the host system executes an otherwise conventional application in a window established and managed by a specific dedicated window sharing application. The principal feature of a window sharing system is the duplication of window display data transferred to a participating guest system. Each guest system also executes a similar window sharing application, configured to receive and display the tapped data in a similarly configured window on the guest system. Since single application are executed in the logical confines of the window, input from a guest is entered, interpreted and then provided to the local host in the form of a interactive session. In addition, this technology is further constrained by the limitation that allows only a single application to operate at any one time. To avoid the need to stop and restart applications, an array of window sessions are started and supported by the proprietary sharing application. As expected, each application then contends for system resources. Thus, with this approach significantly more complex registration and server facilities are generally needed if two or more systems participate and share data or application content with the host system.

The problem with these systems is their inability to communicate effectively with other system, especially desktop computers that contain the applications and data that would be useful to a user of a pen-based display tablet system and personal digital assistants in a remote location. Such information might include, for example, email messages, accounting data or information contained in a word processor document. The exchange of data and application content between a pen-based display tablet and a desktop or host system has been only hindered by the inability to provide a simple but effective means for transferring and translating graphics, images and application content between systems.

### SUMMARY OF THE INVENTION

Thus, a general purpose of the present invention is to provide a mobile or free roaming microprocessor enabled display device suitable for use as a collaborative companion to a corporate user's desktop system.

This is achieved through the use of a personal mobile display system that operate in collaboration with a host computer system that include a processor for executing PC compatible application programs capable of generating and displaying a plurality of operational functions and data in response to user specified input. The host system also includes a wireless data transceiver capable of communicating and exchanging application or system commands and data between the host computer and portable display tablet. The portable display tablet comprises a graphics display panel, a micro-controller, and a wireless transceiver to provide short-range communication between the host computer system and portable display tablet. The micro-controller of the personal mobile display system executes a control program to process the commands and data received from the host computer via the wireless transceiver and provides the resultant application window, template, or graphical display data to the graphics display panel.

The operating environment or control program of the personal mobile display system is an application system that implements screen sharing. This technology provides for the information displayed on the display of a corresponding host system to be transmitted to the personal mobile display system preferably through a suitable network. The screen sharing technology is implemented through establishment of a logical path at the display device driver level of the host computer system. All display data is duplicated and passed through the network to the personal mobile display system. On the personal mobile display system, the control program executes a logically inverse data path to display the monitored data on the touch sensitive screen of the personal mobile display system.

As a result, the application sharing technology used on the personal mobile display system operates independently of any applications executed on the host. In addition, this technology provides application independence to the point that collaborative sharing of well behaved though otherwise ordinary applications, including applications that otherwise could not be executed on a mobile display system, can be made part of the collaboration.

Thus, the advantage of the present invention is that the personal mobile display system provides cost effective, wireless access to a user with the flexibility to interact with and operate applications on his or her desktop system without being tied to computer system at his or her desk.

Another advantage of the present invention is that multiple portable display tablets can be utilized in conjunction with a single network-based computer system to collaboratively provide access to applications executing on that computer system.

### BRIEF DESCRIPTION OF THE DRAWINGS

For a further understanding of the objects and advantages of the present invention, reference should be had to the following detailed description, taken in conjunction with the accompanying drawing, in which like parts are given like reference numerals and wherein:

FIG. 1 is diagram illustrating a preferred embodiment of the invention shown in a typical corporate-wide client/server-networking environment.

FIG. 2 is a diagram showing a cut away view exposing the essential operative elements of the personal mobile display system in accordance with the present invention.

FIG. 3a-FIG. 3c is a flowchart illustrating the relationship between the application programs executing by a remote desktop computer system that produces a data stream communicated to a corresponding personal mobile display system operating in collaboration with a corresponding remote desktop computer system.

### DETAILED DESCRIPTION OF THE INVENTION

The present invention now will be described more fully with reference to the accompanying drawings, in which the preferred embodiments of the invention are shown. While the present invention is described as a single personal mobile display system corresponding a single corresponding host system on a typical local area environment, it should be appreciated by those skilled in the art the benefits and advantages of present invention is also applicable to a corporate-wide client/server environment. The present invention may, however, embodied in many different forms and should not be construed as limited to the embodiment set forth herein; rather these embodiments are provided so that this disclosure will be thorough and complete and will fully convey the invention to those skilled in the art.

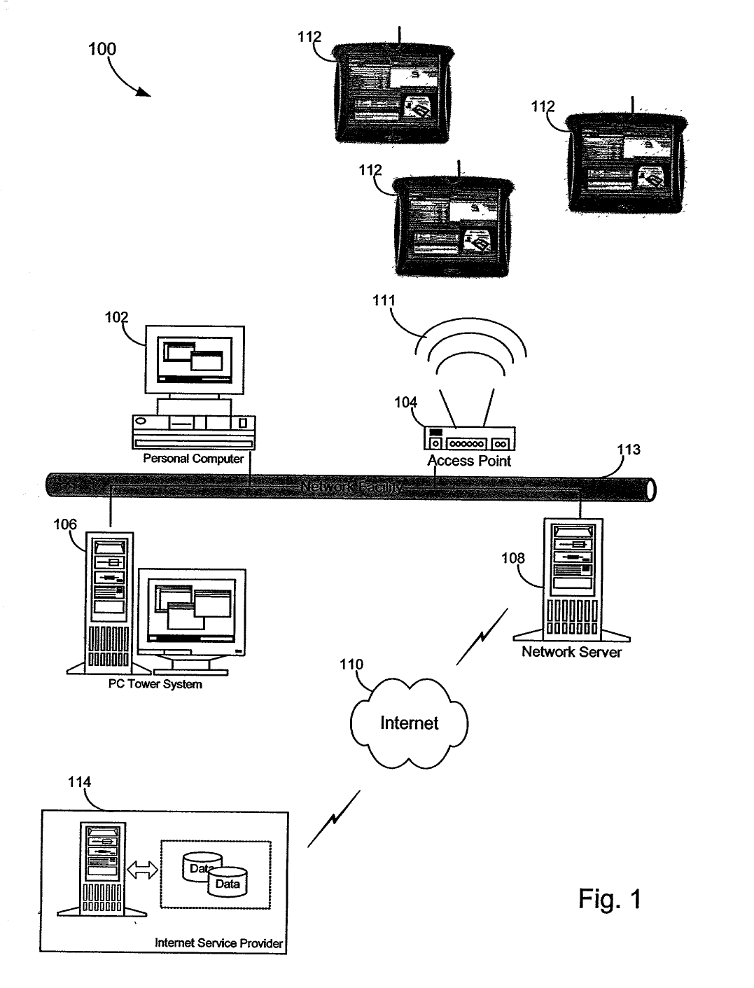

The invention will now be described with respect to FIG. 1, which illustrates the preferred embodiment of the invention shown in a corporate-wide client/server-networking environment 100. The computer network 100 includes several workstations or systems 102, 106 connected via a network facility 113, such as an Ethernet-based local area network, to a server 108. The host systems represented by PC workstation 102 and PC-based tower system 106 shown in FIG. 1, are Intel Pentium™, Microsoft Windows™ based platforms. Each system runs a plurality of commercially available applications as well as, in accordance with the present application, an interactive collaborative application that establishes a wireless communication channel via the network and the access point transceiver 104, to one or more of the personal mobile display systems 112. The interactive collaborative application is not restricted to Intel Pentium™ or Microsoft Windows™ based platforms but rather it is capable of being implemented on any platform, processor or operating system. In addition, the application programs executed by either the PC workstation 102 or PC-based tower system 106 are substantially without restriction in relationship to limitations imposed or potentially imposed by the present invention.

As FIG. 1 shows an access-point transceivers 104 connected to the network 113. Typically, several access-point transceivers 104 will be strategically placed throughout a corporate facility. Each transceiver 104 acts as a bridge between the workstations or systems, represented by PC workstation 102 and PC-based tower system 106, connected to the network and a corresponding personal mobile display system 112. The access point transceivers 104 utilize the IEEE 802.11b Ethernet standard for wireless networks and a corresponding TCP/IP protocol to communicate with the personal mobile display systems 112 within a radius of several hundred feet and at speeds of between one to two megabits per second.

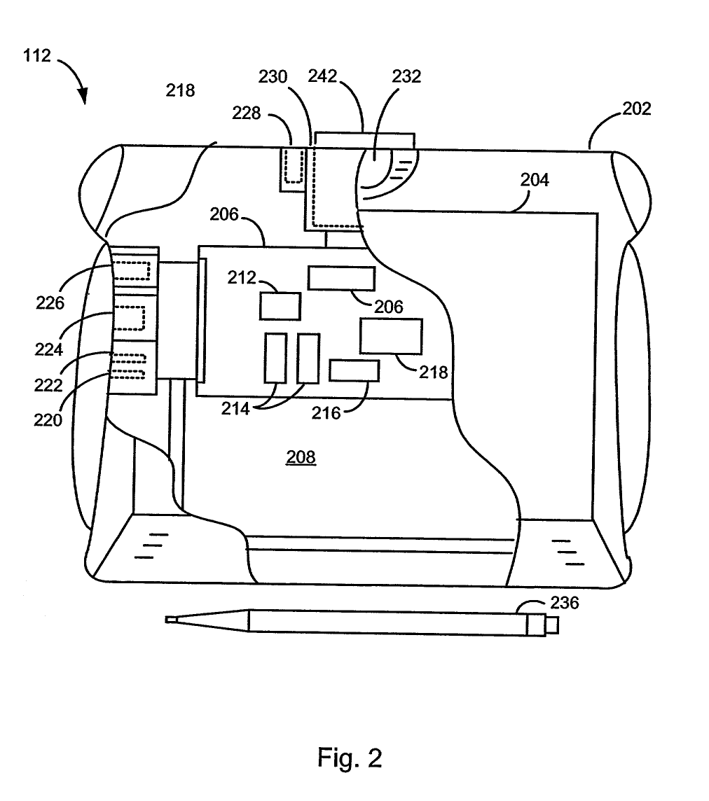

FIG. 2 is a diagram that illustrates a cut away view of the personal mobile display system as implemented by the preferred embodiment of the present invention. The personal mobile display system 112 is approximately ten by thirteen inches in size, weighing less than four pounds providing a user with the flexibility to interact with and operate his or her desktop system without being tied to his or her desk. As FIG. 2 shows a molded plastic enclosure 202 houses a touch sensitive display panel 202, a on-board processing system 206, a high capacity battery 208, a dual PCMCIA CARD slot 222 as well as an array of PC-oriented communications and I/O interfaces 210-228. The touch sensitive display panel 202 can be either an active matrix liquid crystal display (LCD) or a dual-scan super-twist nematic display for rendering suitable color graphic images and application content at a resolution of 800 by 600 pixels or greater. The touch sensitive display panel 202 is lightweight and reasonably sturdy allowing a user to open files, enter information or navigate through application template or windows with the touch of a stylus 238.

The on-board processing system 206 includes an embedded 32-bit RISC-based microprocessor 210, a peripheral controller and co-processor 212, main memory 214 and FLASH memory 216. The main memory 214 is of sufficient size to execute the primary functions of an operating system such as Window CE™ as well as those application programs that are supplied with the personal mobile display system. While most of the FLASH memory 216 is configured as a “solid state” disk to support the operating system. The peripheral controller and co-processor 212 is a companion processor to the embedded 32-bit RISC microprocessor 210 that provides support for a PS/2 keyboard/mouse interface (not shown) and audio CODEC, the PCMCIA slots 230, as well as a host USB port 226, a device USB port 228, a pair of audio ports 220, 222, and a standard VGA port 224. The motherboard 206 also includes a integrated display and graphics controller 218. The integrated display and graphics controller 218 manages the operative functions of the touch sensitive display 204 as well as well as the functions that support a Windows™-like desktop and applications environment. Thus, from a user's prospective, the personal mobile display system 112 is a wireless system that has the look and feel of a Windows™ based computer system that is not constrained by any potential compatibility issues as to type of processor or operating system running on a corresponding desktop system.

As shown in FIG. 2, the personal mobile display system 112 is also configured with a dual PCMCIA slot 230. The dual PCMCIA card slot 222 as shown in outline illustrates its preferred position in back of a portion of the personal mobile display system 112. The dual PCMCIA slot 230 is able to receive up to two the PCMCIA cards. A PCMCIA card 234 inserted in to one of the dual PCMCIA slots 230 that adds desired functionality to the personal mobile display system 112. One of the PCMCIA cards installed in the dual PCMCIA slot 230 is a wireless transceiver that allows the personal mobile display system 112 to remotely communicate with a user's desktop system. Other PCMCIA cards that may be installed to implement such features as enhanced multimedia capabilities, other communications and data connection functions, or encryption and compression capabilities, as well. Since the PCMCIA card 234 is shielded, there is very little, if any, electromagnetic interference between the electronics in the card and the components on the motherboard 206 or the touch sensitive display panel 202 mounted in the enclosure 202. As shown, the personal mobile display system 112 is power by a flat, thin line rechargeable battery pack 208 that can be accessed from a removable panel (not shown) on the back of the personal mobile display system 112. While a high energy flat, thin line rechargeable battery pack 208 is used, the power requirements of the personal mobile display system 112 are closely managed to minimize the load required to support the normal operation of the personal mobile display system 112. The refresh rate and brightness of the touch sensitive display panel 204 may be reduced during periods of perceived inactivity. Also subsystems such as the dual PCMCIA slot 230, the touch sensitive display panel 204, as well as several of the other I/O functions can be selectively powered down when their use is not needed or desired. As a result, the personal mobile display system 112 will have a battery life of approximately four hours.

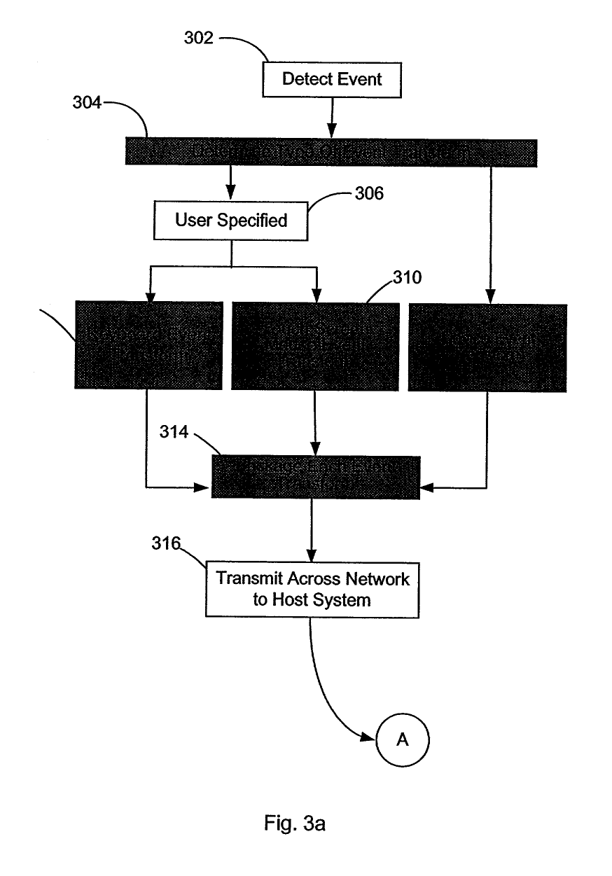

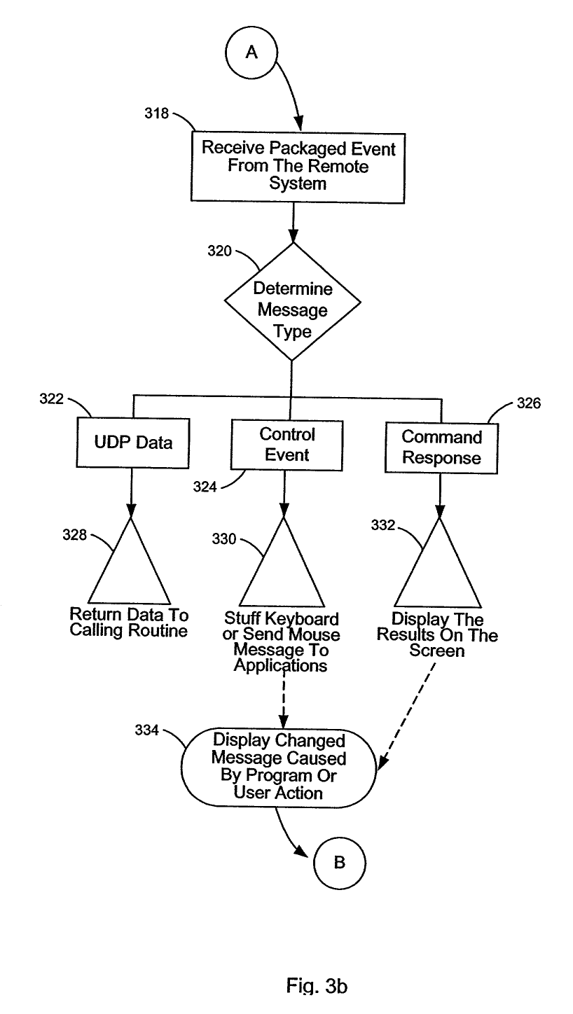

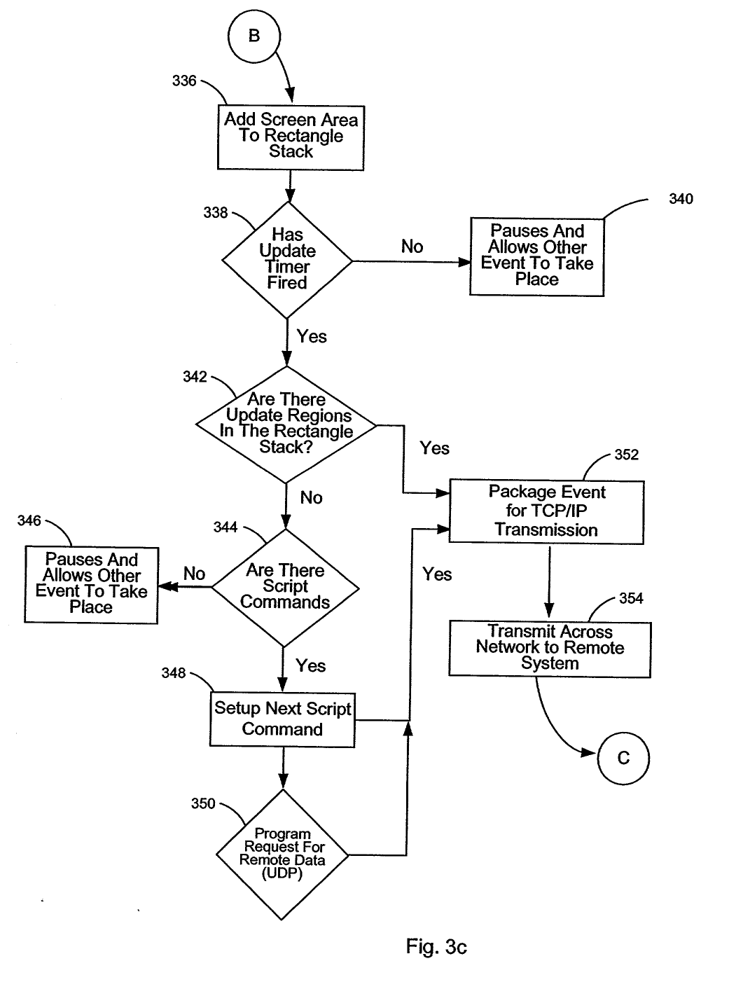

Reference is now made to FIGS. 3a-d that are flowcharts illustrating the steps used to invoke various elements of a cooperative system application on the personal mobile display system that operates on a remote computer system in accordance with FIG. 1. FIG. 3a shows the steps performed by the personal mobile display system to service an event that is encapsulated into an event transform and communicated as an event transform to the corresponding remote computer system. The event transform is an encapsulated user specified or other event properties, methods and actions at a particular point in time. The structure of the event transform provides the ability to reference either prior or historical event, present, or future transform relationships. The encapsulated event can be moved in time and or space to a recipient program or systems object that both interprets and reconstructs the transform into the appropriate action that may include simulating a source event.

As FIG. 3a shows at step 302 the personal mobile display system detects that event transform has occurred. The personal mobile display system at step 304 then determines if it is either a user specified event or another the type of event. If the detected event, as indicated at steps 308 and 310, is a user directed keyboard, mouse, touch screen entry that moves the courser or changes an element of a displayed application, the personal mobile display system, at step 314, encapsulates one or more events in an appropriate format. Once a user specified event has been encapsulated or packaged, the personal mobile display system transmits the event transform across the network via a TCP/IP connected socket or a connectionless UDP datagram to the corresponding host system for processing. For example, multiple interrupts are generated when the stylus moves across the touch sensitive screen of the mobile personal display, which moves the cursor from one point to another. In essence, each of these interrupts is an event that represents an X-Y coordinate of N dimensions that defines the actual movement of the stylus across the screen. The interrupts are then nested or encapsulated into a single event transform that is then transmitted via the network to a corresponding host computer system. Once the event transform has been received, the host system then interprets and reconstructs the contents of the transform into event with an appropriate set of properties and presents it to an application or system program. The application or system program then reproduces a set of interrupts that moves of the cursor across the desktop display of the host in the same manner as the cursor moved across the touch sensitive screen of the mobile personal display.

FIG. 3b shows that at step 318, the host system receives a event transform from the personal mobile display system and at step 320, the host system determines what type of event has been received. If at step 322, the message is data sent from the personal mobile display system is in response made by a host resident routine or application, then, at step 328, the data is then returned to that routine. If a command response or event, at step 326, is received, the host, at step 332, then issues a request to display the results of the command response on the host system.

If the event type, at step 324, is a control event such as a keyboard input or mouse movement caused by the stylus moving across the touch sensitive screen, the host at step 330, sends the keyboard or mouse message to the appropriate application. Once these control events have been received and the changes are made by the appropriate application, the results from the application program and or any user specified actions, at step 334, are then displayed on the host system.

As FIG. 3c shows the rectangular area of the screen where the changes or user specified action has occurred, at step 336, is stored in a display stack used to refresh and update the personal mobile display system in a timely manner. Once the updated rectangular region has been stored, the host system, at step 338, determines if the update time has fired. If the timer has not fire, the host system suspends activity and waits until the timer fires. When the update time fires, the host system, at step 342, determines if there are any updated rectangular areas or regions stored in the stack. If the update timer has not fired, at step 340, there is a pause that allows other events to take place. Once a number of updated rectangular regions have been accumulated in the stack, the host system, at step 352, packages the updated regions and transfers, at step 354, the updated rectangular regions across the network to the personal mobile display system. Additionally, if the host system determines if there are any commands, at step 344, or a program request for data, at step 350, that are needed to be transmitted to the personal mobile display system. The host system then repeats the process, at step 352, of packaging the commands and or any program requests for data, at step 350, and transmits them, at step 354, across the network to the personal mobile display system.

Referring now to FIG. 3d, the personal mobile display system, at step 356, receives a response such as either one or more updated regions, a control command or a program request for data from its host system. The personal mobile display system, at step 358, determines the type of response. For those responses, at step 364, that are updated regions to be displayed, the personal mobile display system, at step 370, then paints the appropriate rectangular areas of the display with the received updated region. If the response, at step 362, is a request for data, the personal mobile display system, at step 368, retrieves the requested data from a local device such as a smart card or a device installed in one of the PCMCIA slots. The personal mobile display system, at step 372, prepares the data for transfer back to the host and then, at step 374, transmits it across the network to the host system. For those responses, at step 360, that are control commands, the personal mobile display system, at step 366, then executes a move cursor command or process a request such as get memory or get network statistics. Once again, the personal mobile display system, at step 372, prepares the responses due to host initiated commands being sent back to the host and then, at step 374, transmits it across the network to the host system.

While the foregoing detailed description has described several embodiments of the golfing game in accordance with this invention, it is to be understood that the above description is illustrative only and not limiting of the disclosed invention. A personal mobile display system and a new thin-client oriented computer system paradigm have been described. While the present invention has been described particularly with reference to those professionals that require access to specific applications such as accounting, projection management, and email on his or her desktop system, the use of personal mobile display system of the present invention is not limited to such an environment. Thus, business and industrial applications resources can be made readily available for concurrent, independent and collaborative access to present on a host system to one or more personal mobile display systems. Furthermore, a personal mobile display system consistent with the present invention is not restricted to operating with only a single host computer. Rather, through the implementation of conventional authentication schemes or procedures, selection of a particular host or set of host computers can be made to support a personal mobile display system in a single corporate facility or used throughout an entire corporate campus.

In view of the above description of the preferred embodiments of the present invention, those of skill in the art will readily appreciate many modifications and variations of the disclosed embodiments. It is therefore to be understood that, within the scope of the appended claims, the invention may be practiced otherwise than as specifically described above.

What is claimed:

1. A method for operating in cooperation with a desktop computer system executing an array of application programs, performed by a personal mobile display system comprising steps of:
detecting that an event transform has occurred;
determining type of event transform wherein an event transform is comprised of a user-directed event or alternatively a device event transform;
interpreting the operative function of each event transform;
converting event transform into the appropriate format for transmissions across network to the corresponding remote desktop computer system;
transmitting event transform across network via at least one communication protocol to the corresponding remote desktop computer system;
receiving packaged event transform from the corresponding computer system; and
displaying the results of event transform received from the corresponding computer system

2. The method as recited in claim 1, wherein the detected event is a user-directed event causes the cursor to move one position to another on the video display screen of the corresponding computer system, where a user-directed event transform that includes a keyboard, a mouse and a screen entry caused by a stylus moving across a touch sensitive screen.

3. The method as recited in claim 1, wherein the detected device event transform communicated to the corresponding computer system includes the operational state of the personal mobile display system, where the operative state includes the status and availability on-board resources of the personal mobile display system.

4. The method as recited in claim 1, wherein the personal mobile display system transmits the packaged event to the corresponding remote computer system across a network via a TCP/IP connected socket to the corresponding host system for processing.

5. The method as recited in claim 4, wherein the personal mobile display system transmits the packaged event across the network to the corresponding remote computer system across a network via a connectionless UDP datagram to the corresponding host system for processing.

6. The method as recited in claim 1, wherein the corresponding host system performs the steps for processing the event transform from received the personal mobile display system comprising:
determining type of event transform to process;
processing event transform in accordance to type of event
displaying wherein changes as a result of host resident application routines, a control event as well as user directed actions in accordance with the processed event transform are displayed on the host system;
storing rectangular display regions containing any changes resulting from an application process or user specified action that has occurred in a display stack, wherein the rectangular display region is used to refresh and update the personal mobile display system;
packaging the stored display regions for transfer to the personal mobile display system; and
transferring the updated rectangular regions across the network to the personal mobile display system.

7. The method as recited in claim 6, wherein if the event transform is data sent from the personal mobile display system in response made by a host resident application routine, then, the data is then returned to that routine.

8. The method as recited in claim 6, wherein if the event transform type is a command response message, the corresponding host system then issues a request to display the results of the command response.

9. The method as recited in claim 6, wherein if event transform type is a control event such as a keyboard input or mouse movement caused by the stylus moving across the touch sensitive screen of the personal mobile display system, the host system sends the keyboard or mouse input to the appropriate application for processing.

10. The method as recited in claim 6, wherein only when a number of updated rectangular regions have been accumulated in the stack does the host system package transfer the updated rectangular regions across the network to the personal mobile display system.

11. The method as recited in claim 6, If the host system determines that there are any commands and a program request for data needed to be transmitted to the personal mobile display system, the host system then repeats the steps of packaging and transmitting the commands and or any program requests for data across the network to the personal mobile display system.

12. The method as recited in claim 1, wherein the personal mobile display system receives a event transform from the corresponding host system, the personal mobile display system determines whether the event transform received is either at least one updated region, a control command or a program request for data.

13. The method as recited in claim 1, wherein if the received event transform is at least one updated region to be displayed, the personal mobile display system, then paints the appropriate rectangular areas of the display with the received updated region.

14. The method as recited in claim 1, wherein if the received event transform is a request for data, the personal mobile display system retrieves the requested data, prepares the data for transfer back to the host and then transmits it across the network to the host system.

15. The method as recited in claim 1, wherein if the received event transform is a control command, the personal mobile display system executes command or processes the request for system status, prepares the response that is due back to the host and then transmits it across the network to the host system.

16. A computer program product that includes a computer useable medium having computer readable code embodied therein that operates in cooperation with a remote system to execute an array of application programs, comprising:
a computer readable program code device of a personal mobile display system configured to detect that an event transform has occurred;
a computer readable program code device of a personal mobile display system configured to determine type of event transform wherein an event transform is comprised of a user-directed event or alternatively a device event transform;
a computer readable program code device of a personal mobile display system configured to interpret the operative function of each event transform;
a computer readable program code device of a personal mobile display system configured to package event transform in appropriate format for transmissions across network to the corresponding remote desktop computer system;
a computer readable program code device of a personal mobile display system configured to transmit packaged event transform across network via at least one communication protocol to the corresponding remote desktop computer system;
a computer readable program code device of a personal mobile display system configured to receive packaged event transform from the corresponding remote desktop computer system; and
a computer readable program code device of a personal mobile display system configured to display the results of event transform received from the corresponding remote desktop computer system

17. The computer program product as recited in claim 16, wherein the detected event is a user-directed event causes the cursor to move one position to another on the video display screen of the corresponding remote desktop computer system, where a user-directed event transform that includes a keyboard, a mouse and a screen entry caused by a stylus moving across a touch sensitive screen.

18. The computer program product as recited in claim 16, wherein the detected device event transform communicated to the corresponding computer system includes the operational state of the personal mobile display system, where the operative state includes the status and availability on-board resources of the personal mobile display system.

19. The computer program product as recited in claim 16, wherein the personal mobile display system transmits the packaged event to the corresponding remote computer system across a network via a TCP/IP connected socket to the corresponding host system for processing.

20. The computer program product as recited in claim 19, wherein the personal mobile display system transmits the packaged event across the network to the corresponding remote computer system across a network via a connectionless UDP datagram to the corresponding host system for processing.

21. The computer program product as recited in claim 16, wherein the corresponding host system performs the steps for processing the event transform from received the personal mobile display system comprising:
a computer readable program code device of a personal mobile display system configured to determine type of event transform to process;
a computer readable program code device of a personal mobile display system configured to process event transform in accordance to type of event
a computer readable program code device of a personal mobile display system configured to display wherein changes as a result of host resident application routines, a control event as well as user directed actions in accordance with the processed event transform are displayed on the host system;
a computer readable program code device of a personal mobile display system configured to store rectangular display regions containing any changes resulting from an application process or user specified action that has occurred in a display stack, wherein the rectangular display region is used to refresh and update the personal mobile display system;
a computer readable program code device of a personal mobile display system configured to package the stored display regions for transfer to the personal mobile display system; and
a computer readable program code device of a personal mobile display system configured to transfer the updated rectangular regions across the network to the personal mobile display system.

22. The computer program product as recited in claim 21, wherein if the event transform is data sent from the personal mobile display system in response made by a host resident application routine, then, the data is then returned to that routine.

23. The computer program product as recited in claim 21, wherein if the event transform type is a command response message, the corresponding host system then issues a request to display the results of the command response.

24. The computer program product as recited in claim 21, wherein if event transform type is a control event such as a keyboard input or mouse movement caused by the stylus moving across the touch sensitive screen of the personal mobile display system, the host system sends the keyboard or mouse input to the appropriate application for processing.

25. The computer program product as recited in claim 21, wherein only when a number of updated rectangular regions have been accumulated in the stack does the host system package transfer the updated rectangular regions across the network to the personal mobile display system.

26. The computer program product as recited in claim 21, wherein if the host system determines that there are any commands and a program request for data needed to be transmitted to the personal mobile display system, the host system then repeats the steps of packaging and transmitting the commands and or any program requests for data across the network to the personal mobile display system.

27. The computer program product as recited in claim 16, wherein the personal mobile display system receives a event transform from the corresponding host system, the personal mobile display system determines whether the event transform received is either at least one updated region, a control command or a program request for data.

28. The computer program product as recited in claim 16, wherein if the received event transform is at least one updated region to be displayed, the personal mobile display system, then paints the appropriate rectangular areas of the display with the received updated region.

29. The computer program product as recited in claim 16, wherein if the received event transform is a request for data, the personal mobile display system retrieves the requested data, prepares the data for transfer back to the host and then transmits it across the network to the host system.

30. The computer program product as recited in claim 16, wherein if the received event transform is a control command, the personal mobile display system executes command or processes the request for system status, prepares the response that is due back to the host and then transmits it across the network to the host system.

31. A system for operating in cooperation with a computer system to execute an array of application programs, performed by a personal mobile display system comprising steps of:
circuitry for detecting that an event transform has occurred;
circuitry for determining type of event transform wherein an event transform is comprised of a user-directed event or alternatively a device event transform;
circuitry for interpreting the operative function of each event transform;
circuitry for packaging event transform in appropriate format for transmissions across network to the corresponding remote desktop computer system;
circuitry for transmitting packaged event transform across network via at least one communication protocol to the corresponding remote desktop computer system;
circuitry for receiving packaged event transform from the corresponding remote desktop computer system; and
circuitry for displaying the results of event transform received from the corresponding remote desktop computer system

32. The system as recited in claim 31, wherein the detected event is a user-directed event causes the cursor to move one position to another on the video display screen of the corresponding remote desktop computer system, where a user-directed event transform that includes a keyboard, a mouse and a screen entry caused by a stylus moving across a touch sensitive screen.

33. The system as recited in claim 31, wherein the detected device event transform communicated to the corresponding computer system includes the operational state of the personal mobile display system, where the operative state includes the status and availability on-board resources of the personal mobile display system.

34. The system as recited in claim 31, wherein the personal mobile display system transmits the packaged event to the corresponding remote computer system across a network via a TCP/IP connected socket to the corresponding host system for processing.

35. The system as recited in claim 34, wherein the personal mobile display system transmits the packaged event across the network to the corresponding remote computer system across a network via a connectionless UDP datagram to the corresponding host system for processing.

36. The system as recited in claim 31, wherein the corresponding host system performs the steps for processing the event transform from received the personal mobile display system comprising:
circuitry for determining type of event transform to process;
circuitry for processing event transform in accordance to type of event;
circuitry for displaying wherein changes as a result of host resident application routines, a control event as well as user directed actions in accordance with the processed event transform are displayed on the host system;
circuitry for storing rectangular display regions containing any changes resulting from an application process or user specified action that has occurred in a display stack, wherein the rectangular display region is used to refresh and update the personal mobile display system;
circuitry for packaging the stored display regions for transfer to the personal mobile display system; and
circuitry for transferring the updated rectangular regions across the network to the personal mobile display system.

37. The system as recited in claim 36, wherein if the event transform is data sent from the personal mobile display system in response made by a host resident application routine, then, the data is then returned to that routine.

38. The system as recited in claim 36, wherein if the event transform type is a command response message, the corresponding host system then issues a request to display the results of the command response.

39. The system as recited in claim 36, wherein if event transform type is a control event such as a keyboard input or mouse movement caused by the stylus moving across the touch sensitive screen of the personal mobile display system, the host system sends the keyboard or mouse input to the appropriate application for processing.

40. The system as recited in claim 36, wherein only when a number of updated rectangular regions have been accumulated in the stack does the host system package transfer the updated rectangular regions across the network to the personal mobile display system.

41. The system as recited in claim 36, If the host system determines that there are any commands and a program request for data needed to be transmitted to the personal mobile display system, the host system then repeats the steps of packaging and transmitting the commands and or any program requests for data across the network to the personal mobile display system.

42. The system as recited in claim 36, wherein the personal mobile display system receives a event transform from the corresponding host system, the personal mobile display system determines whether the event transform received is either at least one updated region, a control command or a program request for data.

43. The system as recited in claim 36, wherein if the received event transform is at least one updated region to be displayed, the personal mobile display system, then paints the appropriate rectangular areas of the display with the received updated region.

44. The system as recited in claim 36, wherein if the received event transform is a request for data, the personal mobile display system retrieves the requested data, prepares the data for transfer back to the host and then transmits it across the network to the host system.

45. The system as recited in claim 36, wherein if the received event transform is a control command, the personal mobile display system executes command or processes the request for system status, prepares the response that is due back to the host and then transmits it across the network to the host system.

46. A method of providing event driven functionality that allows a personal mobile display system to system to cooperatively execute application programs in conjunction with a remote computer system, said method comprising the steps of:
displaying an array of application-oriented attributes of at least one application program on the video display screen of the personal mobile display system wherein the functionality, appearance and logical position of an application-oriented attributes is associated at least one rectangular display segment of the displayed desktop of the personal mobile display system detecting that a change to the functionality, appearance and logical position of an application-oriented functional element has occurred wherein a change to the functionality, appearance and logical position of an application-oriented functional element is defined as an event;
categorizing type of event wherein an event comprises an user-directed event or alternatively a device driven event;
encapsulating at one or more events as an event transform to be transmitted across a network to a corresponding remote computer system wherein the event transform is an encapsulation of at least one source event, method and or actions that may be moved in space and or instance in time between the personal mobile display system and the remote computer system.
transmitting event transform across network via at least one communication protocol to the corresponding remote desktop computer system;
receiving one or more event transforms from the corresponding remote desktop computer system;
reconstructing the refreshed and updated rectangular display segment that were encapsulated in the received event transforms wherein the revised rectangular display segments depicts any changes in functionality, appearance and or logical position of an application-oriented functional element; and
displaying those rectangular display segments that are required to revise the display on the personal mobile display system in accordance with the application program from the remote computer system.

47. The method as recited in claim 46, wherein a change of an application-oriented attribute may be invoked by a user-specified action that includes a keyboard, a mouse or an entry caused by a stylus moving across a touch sensitive display of the personal mobile display system causing the appearance and or logical position of the application-oriented display of the personal mobile display system to change.

48. The method as recited in claim 46, wherein the personal mobile display system transmits the event transform to the corresponding remote computer system through a network to the corresponding host system for processing.

49. The method as recited in claim 46, wherein the corresponding remote computer system performs the steps for processing the event transform from received the personal mobile display system comprising:
determining type of event transform to process;
interpreting and reconstructing appropriate event method and action from the event transform;
processing event transform in accordance to type of event;
displaying wherein changes as a result of host resident application routines, a control event as well as user directed actions in accordance with the processed event transform are displayed on the host system;
storing rectangular display segments containing any changes resulting from an application process or user specified action that has occurred in a display stack, wherein the rectangular display region is used to refresh and update the personal mobile display system;
encapsulating the refreshed and updated rectangular display segment into an event transform to be transferred to the personal mobile display system; and
transferring the updated rectangular regions across the network to the personal mobile display system.

50. The method as recited in claim 49, wherein only when a number of updated rectangular display segments have been accumulated does the host system encapsulate the updated rectangular display segments into an event transform and transfer it through the network to the personal mobile display system.

51. The method as recited in claim 49, If the remote computer system determines that there are any commands and a program request for data needed to be transmitted to the personal mobile display system, the host system then repeats the steps of packaging and transmitting the commands and or any program requests for data across the network to the personal mobile display system.

52. The method as recited in claim 49, wherein the personal mobile display system receives an event transform from the corresponding host system, the personal mobile display system then determines whether the received event transform contains either at least one updated rectangular display segment, a control command or a program request for data.

53. The method as recited in claim 49, wherein if the received event transform is at least one updated rectangular display segment to be displayed, the personal mobile display system, then reconstructs the source properties of the rectangular segment and paints the rectangular segment of the display with the appropriate attributes where these attributes can be source properties, appearance or logical position.

54. A computer program product that includes a computer useable medium having computer readable code embodied therein that provides event driven functionality that allows a personal mobile display system to cooperatively execute application programs in conjunction with a remote computer system, said method comprising the steps of:
a computer readable program code device of a personal mobile display system configured to display an array of application-oriented attributes of at least one application program on the video display screen of the personal mobile display system wherein the functionality, appearance and logical position of an application-oriented attributes is associated at least one rectangular display segment of the displayed desktop of the personal mobile display system;
a computer readable program code device of a personal mobile display system configured to detect that a change to the functionality, appearance and logical position of an application-oriented functional element has occurred wherein a change to the functionality, appearance and logical position of an application-oriented functional element is defined as an event;
a computer readable program code device of a personal mobile display system configured to categorize type of event wherein an event comprises an user-directed event or alternatively a device driven event;
a computer readable program code device of a personal mobile display system configured to encapsulate at one or more events as an event transform to be transmitted across a network to a corresponding remote computer system wherein the event transform is an encapsulation of at least one source event, method and or actions that may be moved in space and or instance in time between the personal mobile display system and the remote computer system.
a computer readable program code device of a personal mobile display system configured to transmit event transform across network via at least one communication protocol to the corresponding remote desktop computer system;
a computer readable program code device of a personal mobile display system configured to receive one or more event transforms from the corresponding remote desktop computer system;
a computer readable program code device of a personal mobile display system configured to reconstruct the refreshed and updated rectangular display segment that were encapsulated in the received event transforms wherein the revised rectangular display segments depicts any changes in functionality, appearance and or logical position of an application-oriented functional element; and
a computer readable program code device of a personal mobile display system configured to display those rectangular display segments that are required to revise the display on the personal mobile display system in accordance with the application program from the remote computer system.

55. The computer program product as recited in claim 54, wherein a change of an application-oriented attribute may be invoked by a user-specified action that includes a keyboard, a mouse or an entry caused by a stylus moving across a touch sensitive display of the personal mobile display system causing the appearance and or logical position of the application-oriented display of the personal mobile display system to change.

56. The computer program product as recited in claim 54, wherein the personal mobile display system transmits the event transform to the corresponding remote computer system through a network to the corresponding host system for processing.

57. The computer program product as recited in claim 54, wherein the corresponding remote computer system performs the steps for processing the event transform from received the personal mobile display system comprising:
a computer readable program code device of a personal mobile display system configured to determine type of event transform to process;
a computer readable program code device of a personal mobile display system configured to interpret and reconstructing appropriate event method and action from the event transform;
a computer readable program code device of a personal mobile display system configured to process event transform in accordance to type of event;
a computer readable program code device of a personal mobile display system configured to display wherein changes as a result of host resident application routines, a control event as well as user directed actions in accordance with the processed event transform are displayed on the host system;
a computer readable program code device of a personal mobile display system configured to store rectangular display segments containing any changes resulting from an application process or user specified action that has occurred in a display stack, wherein the rectangular display region is used to refresh and update the personal mobile display system;
a computer readable program code device of a personal mobile display system configured to encapsulate the refreshed and updated rectangular display segment into an event transform to be transferred to the personal mobile display system; and
a computer readable program code device of a personal mobile display system configured to transfer the updated rectangular regions across the network to the personal mobile display system.

58. The computer program product as recited in claim 57, wherein only when a number of updated rectangular display segments have been accumulated does the host system encapsulate the updated rectangular display segments into an event transform and transfer it through the network to the personal mobile display system.

59. The computer program product as recited in claim 57, If the remote computer system determines that there are any commands and a program request for data needed to be transmitted to the personal mobile display system, the host system then repeats the steps of packaging and transmitting the commands and or any program requests for data across the network to the personal mobile display system.

60. The computer program product as recited in claim 57, wherein the personal mobile display system receives an event transform from the corresponding host system, the personal mobile display system then determines whether the received event transform contains either at least one updated rectangular display segment, a control command or a program request for data.

61. The computer program product as recited in claim 57, wherein if the received event transform is at least one updated rectangular display segment to be displayed, the personal mobile display system, then reconstructs the source properties of the rectangular segment and paints the rectangular segment of the display with the appropriate attributes where these attributes can be source properties, appearance or logical position.

62. A system that provides event driven functionality that allows a personal mobile display system to system to cooperatively execute application programs in conjunction with a remote computer system, said method comprising the steps of:
circuitry for displaying an array of application-oriented attributes of at least one application program on the video display screen of the personal mobile display system wherein the functionality, appearance and logical position of an application-oriented attributes is associated at least one rectangular display segment of the displayed desktop of the personal mobile display system; circuitry for detecting that a change to the functionality, appearance and logical position of an application-oriented functional element has occurred wherein a change to the functionality, appearance and logical position of an application-oriented functional element is defined as an event;
circuitry for categorizing type of event wherein an event comprises an user-directed event or alternatively a device driven event;
circuitry for encapsulating at one or more events as an event transform to be transmitted across a network to a corresponding remote computer system wherein the event transform is an encapsulation of at least one source event, method and or actions that may be moved in space and or instance in time between the personal mobile display system and the remote computer system circuitry for transmitting event transform across network via at least one communication protocol to the corresponding remote desktop computer system;
circuitry for receiving one or more event transforms from the corresponding remote desktop computer system;
circuitry for reconstructing the refreshed and updated rectangular display segment that were encapsulated in the received event transforms wherein the revised rectangular display segments depicts any changes in functionality, appearance and or logical position of an application-oriented functional element; and
circuitry for displaying those rectangular display segments that are required to revise the display on the personal mobile display system in accordance with the application program from the remote computer system.

63. The system as recited in claim 62, wherein a change of an application-oriented attribute may be invoked by a user-specified action that includes a keyboard, a mouse or an entry caused by a stylus moving across a touch sensitive display of the personal mobile display system causing the appearance and or logical position of the application-oriented display of the personal mobile display system to change.

64. The system as recited in claim 62, wherein the personal mobile display system transmits the event transform to the corresponding remote computer system through a network to the corresponding host system for processing.

65. The system as recited in claim 62, wherein the corresponding remote computer system performs the steps for processing the event transform from received the personal mobile display system comprising:
determining type of event transform to process;
interpreting and reconstructing appropriate event method and action from the event transform;
processing event transform in accordance to type of event;
displaying wherein changes as a result of host resident application routines, a control event as well as user directed actions in accordance with the processed event transform are displayed on the host system;
storing rectangular display segments containing any changes resulting from an application process or user specified action that has occurred in a display stack, wherein the rectangular display region is used to refresh and update the personal mobile display system;
encapsulating the refreshed and updated rectangular display segment into an event transform to be transferred to the personal mobile display system; and
transferring the updated rectangular regions across the network to the personal mobile display system.

66. The system as recited in claim 65, wherein only when a number of updated rectangular display segments have been accumulated does the host system encapsulate the updated rectangular display segments into an event transform and transfer it through the network to the personal mobile display system.

67. The system as recited in claim 65, If the remote computer system determines that there are any commands and a program request for data needed to be transmitted to the personal mobile display system, the host system then repeats the steps of packaging and transmitting the commands and or any program requests for data across the network to the personal mobile display system.

68. The system as recited in claim 65, wherein the personal mobile display system receives an event transform from the corresponding host system, the personal mobile display system then determines whether the received event transform contains either at least one updated rectangular display segment, a control command or a program request for data.

69. The system as recited in claim 65, wherein if the received event transform is at least one updated rectangular display segment to be displayed, the personal mobile display system, then reconstructs the source properties of the rectangular segment and paints the rectangular segment of the display with the appropriate attributes where these attributes can be source properties, appearance or logical position.
